(19) United States
(12) Patent Application Publication
(10) Pub. No.: US 2018/0185815 A1
(43) Pub. Date: Jul. 5, 2018

(54) Coating for Capturing Sulfides

(71) Applicant: Dow Global Technologies LLC, Midland, MI (US)

(72) Inventors: Fabio Aguirre Vargas, Lake Jackson, TX (US); Arjun Raghuraman, Pearland, TX (US); Alexander Williamson, Rosharon, TX (US); Sachit Goyal, Houston, TX (US); Juan Carlos Medina, Lake Jackson, TX (US)

(21) Appl. No.: 15/738,774

(22) PCT Filed: Jun. 20, 2016
(86) PCT No.: PCT/US2016/038404

§ 371 Date: Dec. 21, 2017

Related U.S. Application Data
(60) Provisional application No. 62/186,669, filed on Jun. 30, 2015.
(60) Provisional application No. 62/186,671, filed on Jun. 30, 2015.
(60) Provisional application No. 62/186,645, filed on Jun. 30, 2015.
(60) Provisional application No. 62/287,037, filed on Jan. 26, 2016.
(60) Provisional application No. 62/312,113, filed on Mar. 23, 2016.
(60) Provisional application No. 62/324,542, filed on Apr. 19, 2016.

(51) Int. Cl. B01J 20/06; B01J 20/26; B01J 20/28; B01J 20/30; B01J 20/32; C09D 175/04; C09D 5/08; C09D 163/00; B01D 15/00; C02F 1/28

(52) U.S. Cl. CPC B01J 20/06; B01J 20/262; B01J 20/28026; B01J 20/3085; B01J 20/3236; C08K 2003/2296; C09D 5/084; C09D 163/00; B01D 15/00; C02F 1/281; C09D 175/04

(57) ABSTRACT

A sulfide recovery coating for containers, tanks, pipes, and pipelines, which sulfide recovery coating includes a sulfide capturing agent embedded within a polymer resin matrix. The sulfide capturing agent is a metal oxide and accounts for less than 70 wt % of a total weight a composition for forming the sulfide recovery coating.

### FIELD

Embodiments relate to coatings for base substrate such as containers, tanks, pipes, and pipelines that are enabled for capturing of sulfides (e.g., recovery of sulfides, scavenging of sulfides, trapping of sulfides, and/or removal of sulfides like hydrogen sulfide, which are all individually and collectively can be referred to as enabling capturing and/or recovery of sulfides herein), articles that have the coatings thereon, methods of making the coatings, and methods of coating the articles such containers, tanks, pipes, and pipelines with the coatings.

### INTRODUCTION

Polymeric protective coatings (which include set in place coatings, spray coatings, powder coatings, and paints) may be used to protect metal and concrete substrates from corrosion by providing a barrier between a corrosive environment and a substrate. The protective coatings may be designed to minimize the permeation through the polymer of corrosive species commonly found in aqueous or organic media. It is proposed that the protective coating may enable capturing and/or recovery of sulfides, such as by way of removing hydrogen sulfide. For example, it is proposed the protective coating may contain materials that react with a corrosive compound such as hydrogen sulfide in the aqueous or organic media, which would be capable of capturing sulfides, recovering of sulfides, trapping of sulfides, scavenging of sulfides and/or removal of sulfides like hydrogen sulfide from the aqueous or organic media.

### SUMMARY

Embodiments may be realized by providing a sulfide recovery coating for containers, tanks, pipes, and pipelines, which sulfide recovery coating includes a sulfide capturing agent embedded within a polymer resin matrix. The sulfide capturing agent is a metal oxide and accounts for less than 70 wt % of a total weight a composition for forming the sulfide recovery coating. Embodiments may also be realized by providing a coated article that includes a base substrate and the sulfide recovery coating on the base substrate.

### BRIEF DESCRIPTION OF THE DRAWINGS

FIG. 1 illustrates an exemplary schematic cross-sectional view of layers of a pipe structure including a coating that is a permeable layer.

### DETAILED DESCRIPTION

Improved coatings, e.g., for base substrates such as containers, tanks, pipes, pipelines, tubes, tubing, or other cylindrical member, that combine the strength and/or flexibility of a polymer resin based coated (such as at least one selected from the group of a polyurethane based coating and/or an epoxy based coating) with a contaminant capturing/removal substance are sought. The base substrate may be a metal, a metal alloy, or a composite material (such as a reinforced theremoplastic material, glass, or concrete). The sulfide recovery coating (which may also be referred to as a sulfide capturing coating) may be formed on or attached to the surface of the base substrate. The sulfide recovery coating may be formed on or attached to the surface of the base substrate, with or without use of an undercoat layer such as a primer. For example, the sulfide recovery coating may be formed on or attached directly to the surface of the base surface, without use of the primer there between, so as to realize advantages associated with a direct to metal application of the coating.

For example, the coatings, according to exemplary embodiments, may incorporate/embed at least a sulfide capturing agent into a polymer resin based matrix in order to provide strength and/or flexibility to both the overall base substrate and the layer that incorporates/embeds the sulfide capturing agent. The coating is also referred to herein as a sulfide recovery coating and the sulfide capturing agent may be referred to herein as sulfide capturing substance and/or sulfide recovery agent. For example, a coated pipe or pipeline may be useful for capturing sulfides from liquids passing through an interior passageway. The pipe or pipeline may be a reinforced thermoplastic pipe (RTP), a cure in place pipe (CIPP), or a pultruded pipe. In another example, a coated container or tank may be useful for capturing sulfides from materials stored therewithin.

In an exemplary embodiment, the coating may be a permeable layer, such as a permeable liner. Exemplary permeable liners are discussed in U.S. Provisional Application No. 62/186,671. By permeable it is meant a sulfide-containing liquid such as water, may penetrate into the coating. As discussed in U.S. Provisional Application No. 62/186,671, the permeability of the layer may be determined by measuring the glass transition temperature (Tg) of the layer, before and after wetting the liner with water and correlating the Tg measurements to permeability. Another way to measure the liner permeability is using Electrochemical Impedance Spectroscopy (EIS), measures the dielectric properties of a medium as a function of frequency. Yet another way to measure liner permeability is by measuring the weight of the liner before and after exposing it to water at for instance 90° C. for at least 24 hours.

With respect to contaminant capturing, failure to maintain acceptable levels of hydrogen sulfide in the contaminated fluids may lead to corrosion of casings (sulfide-stress corrosion cracking), mechanical failure, fluid leakage, and/or environmental contamination. Also, corrosion problems may be an issue for gas pipelines to transport natural gas, oil, and/or other hydrocarbons over long distances, such that the hydrocarbons may need to be treated so that hydrogen sulfide levels are below a certain specified limit (e.g., a limit specified by a pipeline operator and/or owner). Further, with respect to sulfides such as hydrogen sulfide, contaminated fluids such as water may exhibit souring, which refers to an increased mass of hydrogen sulfide per unit mass of total fluid. For example, the contaminated fluids may result from well fracturing, which is a process of injecting a fracturing fluid at high pressure into subterranean rocks, well holes, etc., so as to force open existing fissures and extract oil or gas therefrom.

Hydrogen sulfide, such as in in oil or gas wells, may result from biogenic or non-biogenic sources. Biogenic pathways for hydrogen sulfide may result from microbial contamination by sulfate-reducing bacteria, which convert sulfate to hydrogen sulfide in the absence of oxygen. Further, water used in well fracturing may be sourced from rivers, lakes, or wastewater impoundments where they have been stored for prolonged periods, and these water sources may be rich in bacteria. Non-biogenic pathways for hydrogen sulfide production including: (i) thermochemical sulfate reduction, (ii) decomposition of organic sulfur compounds, (iii) dissolution of pyritic material, and (iv) redox reactions involving bisulfite oxygen scavengers. Modifying contaminated fluids to include compounds that may control hydrogen sulfide such as biocides to kill bacteria, may not be productive to control non-biogenic pathways for hydrogen sulfide production. Further, the hydrolytic and thermal stability of biocides may hinder certain uses.

Accordingly, embodiments relate to providing a system in which sulfides such as hydrogen sulfide may be removed from contaminated fluids, e.g., can be absorbed into/onto a matrix and/or may be chemically altered. For example, the sulfide may be chemically altered to form sulfur dioxide. In particular, embodiments relate to providing a sulfide capturing agent embedded within a polymer resin matrix, which is coated onto the base substrate. The sulfide capturing agent may aid in the capturing and/or removal of sulfides from the contaminated fluids. According to exemplary embodiments, the sulfide capturing agent may have a low solubility in water, e.g., sulfide capturing agents that have a high solubility in water may be limited and/or avoided as the use of such agents may be disadvantageous for use in water-rich environments such as containers, tanks, pipes, and pipelines. For example, the sulfide capturing agent may have a water solubility of less than 10.0 mg/L at 29° C., less than 5.0 mg/L at 29° C., and/or less than 2.0 mg/L at 29° C.

The polymer resin matrix having the sulfide capturing agent may act as a permeable or semi-permeable polymer resin, with respect to hydrogen sulfide and/or sulfur ions. For example, the hydrogen sulfide and/or sulfur ions may be rendered immobile on an outer surface of the sulfide recovery coating and/or rendered immobile within the polymer resin matrix of the sulfide recovery coating. The polymer resin matrix, polymer coating, and/or the process used to prepare the coating may be designed to retain captured sulfide on or within the coatings. The polymer resin matrix may provide the additional benefit of being formulated to maintain its properties even when exposed to high temperature, e.g., to temperatures of at least 70° C. The performance of coatings, especially at higher temperatures (such as greater than 120° C.), may be further improved by designing a multilayer coating structure, where the top layer may be permeable or semi-permeable, while the undercoat layer may be composed of polymer resin matrix that can retain a high storage modulus at high temperatures (such as up to at least 175° C.). For example, the underlying polymer resin matrix may include polyurethane based polymers and/or epoxy based polymers (which encompasses polyurethane/epoxy hybrid polymers), which offer various advantages, e.g., such as ease of processing, and/or rapid cure rates that enable short cycle times for forming the coating. Further, polyurethane polymers and/or epoxy polymers may be readily formulated to provide a permeable or semi-permeable layer with one formulation, and a high storage modulus layer with another formulation, in some cases using the same combination of raw materials but at different ratios.

The sulfide capturing agent may enable self-passivation of the coating. For example, as discussed in in U.S. Patent Publication No. 2012/0164324, a metal oxide layer that is reactive with hydrogen sulfide is disclosed, upon which reaction with hydrogen sulfide the metal oxide layer forms a barrier layer that resists the transmission of hydrogen sulfide across it. This modified metal oxide layer is conceived of as a self-passivating layer in that reactivity toward hydrogen sulfide is diminished over time in the presence of hydrogen sulfide. Yet, its barrier properties, with respect to the transmission of hydrogen sulfide, are enhanced as a function of the extent to which the modified metal oxide layer has been converted to a sulfide or oxysulfide barrier layer. However, to achieve such self-passivation, U.S. Patent Publication No. 2012/0164324 requires a coating composition that includes a metal oxide precursor material that is susceptible to conversion to the corresponding metal oxide, which precursor material may be may be a metal derivative that which upon reaction with water forms the corresponding metal oxide (as is the case of zinc acetate and tetraethyl orthosilicate) or a metal derivative that which may be transformed into a metal oxide without the intervention of water (such as a metal oxalate). In contrast, the exemplary embodiments relate to enabling self-passivation, in addition to the benefits associated with the polymer resin matrix, without requiring special additives.

In embodiments, the base substrate is coated with at least a sulfide recovery coating that includes at least the sulfide capturing agent, which is embedded within the polymer resin matrix. For example, the sulfide capturing agent may be introduced with a composition for forming the polymer resin matrix, so as to be mixed within the composition. The base substrate may be coated with a sulfide recovery coating containing additional additives, such as additives for recovery, capturing, and/or removal of other contaminates. The sulfide recovery coating may be at least a dual function coating that provides the benefit of sulfide recovery/capturing and the additional benefit associated with resin coatings. The base substrate may include one or more sulfide recovery coatings/layers. The base substrate may include one or more polymer resin coating/layers, e.g., one or more polyurethane based coatings/layers, one or more epoxy based coatings/layers (which encompasses one or more polyurethane/epoxy hybrid based coatings/layers), and/or one or more phenolic-resin based coatings/layers. The base substrate may include additional coatings/layers derived from one or more preformed isocyanurate tri-isocyanates and one or more curatives. The different coatings/layers may be sequentially formed and/or may be formed at different times. The sulfide recovery coating may be formed on a pre-formed polymer resin coated base substrate or may be formed immediately after and/or concurrent with forming a polymer resin coating on the base substrate.

For example, the sulfide recovery coating may be applied to applications such as to coat the interior of tubes, pipe, and/or pipelines (e.g., that are used in well fracturing and/or waste water management). The sulfide recovery coating may be applied onto concrete primary and/or secondary containments (e.g., tanks, waste water treatment plant, etc.) The sulfide recovery coating may be applied to containers and/or tanks, such as large industrial containers (e.g., industrial containers that hold more than 10,000 gallons). The large industrial containers may be used to hold abrasive and/or corrosive materials. For example, large industrial containers such as frac tanks are used in the oil and gas industry to store and transport hydraulic fracturing fluids to and from well sites. Since the hydraulic fracturing fluid may include corrosive materials such as hydrochloric acid and toxic solvents such as toluene and xylene, to reduce and/or minimize the possibility of leakage the frac tank (e.g., the interior) may be lined with a protective coating. Due to the large surface area of the containers, protective coatings that both are sprayable onto large surface areas and impart chemical resistance may be sought.

With respect to piping, various methods and pipe structures have been proposed for removing contaminants from the fluids flowing through the center passageway of pipe structures. Proposed methods for removing contaminants are commonly based on coatings applied to the inner surface of a pipe substrate for traditional piping applications. For example, U.S. Pat. Nos. 8,726,989 and 8,746,335, generally disclose a method for removing contaminants from wastewater in a hydraulic fracturing process utilizing a pipe coating that includes a contaminant-capturing substance for capturing contaminants such as toxic and radioactive materials from wastewater flowing through the pipe. However, U.S. Pat. Nos. 8,726,989 and 8,746,335, fail to disclose the specific coating taught herewithin.

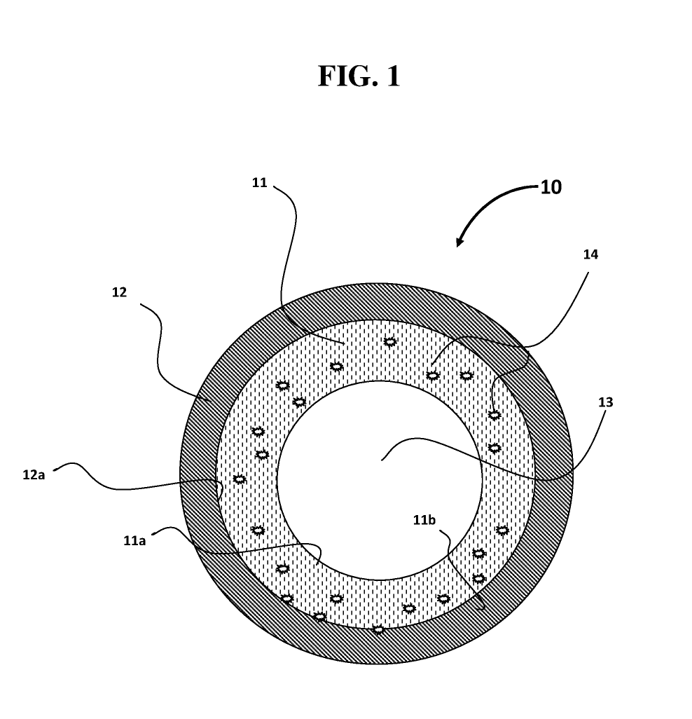

An exemplary embodiment of the coating is shown in FIG. 1. In particular, in FIG. 1, a multi-layer article 10 having a cylindrical structure as a base substrate 12 is illustrated. The cylindrical structure includes a coating 11 integrally attached to an interior surface 12a of the base substrate 12. An interior surface 11a of the coating 11 forms an inner space surrounded by the base substrate 12, which inner space is indicated by numeral 13. An exterior surface 11b of the coating is directly on the base substrate 12. Further, the coating 11 includes a filler particle material 14, e.g., a sulfide capturing agent, embedded within and integrally incorporated in coating 11.

### Sulfide Recovery Coating

In embodiments, the base substrate includes at least one sulfide recovery coating, which may be the top coat (outermost coating). The sulfide recovery coating includes at least one sulfide capturing agent embedded on and/or within a polymer resin matrix, such as a polyurethane polymer matrix. The sulfide capturing agent may be sulfide capturing crystals. The sulfide capturing agent may be added during a process of forming the sulfide recovery coating and/or may be sprinkled onto a previously coated base substrate (e.g., added after applying an underlying layer) to form the sulfide recovery coating in combination with the underlying layer. The sulfide recovery coating may include other additives, such as agents for heavy metal removal and/or capturing.

For example, the sulfide capturing agent may be at least in part embedded with a matrix of a polymer resin, such that optionally the sides of the sulfide capturing agent are encapsulated by the polymer resin. The sulfide capturing agent may be at least in part directly on to top of the matrix of polymer resin, so that bottom surfaces of the sulfide capturing agent are surrounded by the polymer resin. The sulfide capturing agent may account for less than 70 wt %, less than 50 wt %, and/or less than 35 wt %, of a total weight of the composition for forming the sulfide recovery coating and/or a total weight of the resultant sulfide recovery coating. The sulfide capturing agent may account for greater than 1.0 wt %, greater than 5.0 wt %, and/or greater 10.0 wt % of the total weight of the composition for forming the sulfide recovery coating. The composition may be a one or two component system.

The sulfide capturing agent may account for 1 wt % to 99 wt % (e.g., 15 wt % to 85 wt %, etc.) of the total weight of the sulfide recovery coating. The sulfide capturing agent may account for 1 vol % to 30 vol % (e.g., 5 vol % to 25 vol %, 7 vol % to 20 vol %, etc.) of the total volume of the sulfide recovery coating. The remainder of the volume of the coating may be the polymer resin, whereas any solvent used in applying the coating may be evaporated in the final coating. The amount of the sulfide capturing agent in the sulfide recovery coating may vary depending on how the sulfide recovery coating is formed, the overall thickness of the sulfide recovery coating, and/or whether the sulfide recovery coating is formed as a separate layer from any optional undercoat.

The sulfide capturing agent may be added as part of a one-component system or a two-component system. For example, the sulfide capturing agent may be used in an one-component polyurethane, and/or epoxy system or a two-component polyurethane, phenolic, and/or epoxy systems. For example, the sulfide capturing agent may be incorporated into an isocyanate-reactive component for forming the sulfide recovery coating, an isocyanate component (e.g., a polyisocyanate and/or a prepolymer derived from an isocyanate and a prepolymer formation isocyanate-reactive component) for forming the sulfide recovery coating, the prepolymer formation isocyanate-reactive component, and/or a prepolymer derived from an isocyanate and a one component system formation isocyanate-reactive component (such as for a moisture cured one-component polyurethane system).

Exemplary sulfide capturing agents are metal oxides. For example, the metal oxides may be derived from metals described as Period 4 Elements in the periodic table of elements. Exemplary metal oxides include zinc oxides, iron oxides, titanium oxides, and/or combinations thereof. Examples include zinc oxide, zinc-titanium oxide, and magnetite. The microstructure of the sulfide capturing agent may allow for the metal, such as zinc, to react with hydrogen sulfide to form zinc sulfide and water.

The sulfide capturing agents (e.g., sulfide capturing crystals) are solids at room temperature (approximately 23° C.). The sulfide capturing crystals may have a melting point greater than 500° C., greater than 800° C., and/or greater than 1000° C. The melting point of sulfide capturing crystals may be less than 2500° C. The sulfide capturing crystals may be metallic materials that form a crystalline matrix (also referred to as a crystal lattice) appropriately sized to allow for absorption of sulfides. The sulfide capturing agents, such as the sulfide capturing crystals, may have an average particle size of less than 5 μm (e.g., less than 4 μm, less than 2 μm, less than 1 μm, etc.) For example, the average particle size may be from 25 nm to 500 nm (e.g., 25 nm to 250 nm, 50 nm to 200 nm, 100 nm to 200 nm, etc.) The sulfide capturing agent may account for 90 wt % to 100 wt % (e.g., 99 wt % to 100 wt %) of a crystalline content in the sulfide recovery coating. The sulfide capturing agents may be of low solubility in water.

The sulfide capturing agents may be added directly and/or also as a slurry in water, during a process of forming the sulfide recovery coating. Optionally, the sulfide capturing agents may be provided in a carrier polymer when forming the sulfide recovery coating. Exemplary carrier polymers include simple polyols, polyether polyols, polyester polyols, natural oil polyols, natural oil derived polyols, liquid epoxy resin, liquid acrylic resins, polyacids such as polyacrylic acid, a polystyrene based copolymer resins (exemplary polystyrene based copolymer resins include crosslinked polystyrene-divinylbenzene copolymer resins), Novolac resins made from phenol and formaldehyde (exemplary Novolac resins have a low softening point), isocyanate-terminated prepolymers, and combinations thereof. More than one carrier polyol may be used, e.g., a combination of a liquid epoxy resin with sulfide capturing agents therein and a carrier polyol with sulfide capturing agents therein may be used. The carrier polyol may be a resin that is crosslinkable so as to provide a permeable or semi-permeable layer on the base substrate.

The carrier polymer may be present in an amount from 15 wt % to 85 wt %, based on the total weight of the sulfide capturing agents and the carrier polymer. The carrier polymer may include a blend of different polymers, e.g., a blending of polyols. The amount of the carrier polymer used may be lower when the sulfide recovery coating is formed immediately after a polymer resin undercoat layer is formed (e.g., a polyurethane based undercoat layer). In an exemplary embodiment, the carrier polymer may be a mixture of a hydrophilic polymer in water (e.g., glycerol, blend of glycerol and a hydrophilic polyether polyol available from The Dow Chemical Company, a blend of water and the hydrophilic polyether polyol, and/or a blend glycerol, water, and the hydrophilic polyether polyol. The inclusion of water may help mitigate zinc oxide agglomeration of hydrophilic zinc oxide grades in the resultant coating. The amount of the carrier polymer used may be higher when the sulfide recovery coating is formed concurrent with a polymer resin layer such as a polyurethane based layer and/or epoxy based layer (i.e., a prior polymer resin undercoat layer is not formed). In exemplary embodiments, the carrier polymer includes one or more simple polyols, one or more polyether polyols, one or more liquid epoxy resins, one or more phenolic resins, and/or combinations thereof.

In exemplary embodiments, the carrier polymer may include one or more carrier polyols having a number average molecular weight from 60 g/mol to 6000 g/mol. The carrier polyol may have on average from 1 to 8 hydroxyl groups per molecule, e.g., from 2 to 4 hydroxyl groups per molecule. For example, the one or more carrier polyols may independently be a diol or triol. In some exemplary embodiments, the carrier polymer has a number average molecular weight, e.g., 60 g/mol to 3000 g/mol, 60 g/mol to 2000 g/mol, 60 g/mol to 1500 g/mol, 60 g/mol to 1000 g/mol, 60 g/mol to 500 g/mol, 60 g/mol to 400 g/mol, 60 g/mol to 300 g/mol, etc. For example, the carrier polymer include a simple polyol that includes at least two —OH moieties, and has a number average molecular weight from 60 g/mol to 500 g/mol (e.g., from 60 g/mol to 400 g/mol, 60 g/mol to 300 g/mol, etc.). Exemplary simple polyols may consist of Carbon, Oxygen, and Hydrogen. Exemplary simple polyols include ethylene glycol, diethylene glycol, triethylene glycol, 1,2-propanediol, dipropylene glycol, tripropylene glycol, 1,4-butanediol, 1,6-hexanediol, glycerol, and the like simple polyols that may be used as the initiator for forming a polyether polyol (as would be understood by a person of ordinary skill in the art).

In exemplary embodiments, the carrier polymer may include a polyether polyol that has a high number average molecular weight, e.g., from 300 g/mol to 3000 g/mol, 300 g/mol to 1500 g/mol, 500 g/mol to 1000 g/mol, etc. For example, the polyether polyol may be a hydrophilic polyol, e.g., an ethylene oxide (EO) rich polyether polyol that has an EO content of greater than 50 wt % (e.g., from 60 wt % to 95 wt %, 65 wt % to 90 wt %, 70 wt % to 85 wt %, etc.), based on the total weight of the ethylene oxide rich polyether polyol. EO content is calculated by the mass of EO monomer units reacted into the polyether polyol divided by the total mass of the polyether polyol. So for polyols with water, ethylene glycol, diethylene glycol, or other linear oligomers of EO used as initiator, the EO content may be as high as 100 wt %, but for other initiators, the maximum EO content may be lower than 100 wt %.

The carrier polyol may include any combination thereof, e.g., a combination of the polyether polyol and the simple polyol. For example, the carrier polyol may include from 1 wt % to 99 wt % of one or more polyether polyols and from 1 wt % to 99 wt % of one or more simple polyols.

In exemplary embodiments, the carrier polymer may include a liquid epoxy resin that forms an epoxy based matrix in a final curable formulation. For example, useful epoxy compounds may include any conventional epoxy compound. The epoxy compound used, may be, e.g., a single epoxy compound used alone or a combination of two or more epoxy compounds known in the art such as any of the epoxy compounds described in Lee, H. and Neville, K., Handbook of Epoxy Resins, McGraw-Hill Book Company, New York, 1967, Chapter 2, pages 2-1 to 2-27. The epoxy resin may be based on reaction products of polyfunctional alcohols, phenols, cycloaliphatic carboxylic acids, aromatic amines, or aminophenols with epichlorohydrin. For example, the liquid epoxy resin may be based on bisphenol A diglycidyl ether, bisphenol F diglycidyl ether, resorcinol diglycidyl ether, or triglycidyl ethers of para-aminophenols. Other exemplary epoxy resins include reaction products of epichlorohydrin with o-cresol and, respectively, phenol novolacs. Exemplary, commercially available epoxy related products include, e.g., D.E.R.™ 331, D.E.R.™ 332, D.E.R.™ 334, D.E.R.™ 580, D.E.N.™ 431, D.E.N.™ 438, D.E.R.™ 736, or D.E.R.™ 732 epoxy resins available from Olin Epoxy. In exemplary embodiments, when the liquid epoxy resin is used as a carrier polymer, a polyurethane based undercoat may be formed on the base substrate.

In embodiments, the polymer resin matrix includes, e.g., one or more polyurethane resins, one or more epoxy resins, one or more polyurethane/epoxy hybrid resins, and/or one or more phenolic resins (including phenolic-formaldehyde based). Optionally, one or more polymer resin based undercoats may be formed under the polymer resin matrix of the sulfide recovery coating, e.g., one or more phenolic based undercoats (including phenolic-formaldehyde based), one or more epoxy resin based undercoats, and/or one or more polyurethane resin based undercoats. For example, the epoxy resin, and/or polyurethane resin based undercoat layer may be a coating that is known in the art, e.g., known in the art for containers, tanks, pipes, and/or pipelines. The undercoat may be a primer that is known in the art for use in containers, tanks, pipes, and/or pipelines.

Optionally, additional coatings/layers may be formed under the polymer resin matrix. In exemplary embodiments, the polymer resin matrix is a polyurethane based matrix, and the optional one or more polymer resin based undercoats (if included) includes at least one polyurethane resin and/or epoxy resin based undercoat. For example, if the polymer resin matrix is an epoxy based matrix, the optional one or more polymer resin based undercoats (if included) includes at least one polyurethane based undercoat and/or epoxy resin based undercoat (which encompasses polyurethane/epoxy hybrid undercoats). The optional polymer resin based undercoat may include at least 75 wt %, at least 85 wt %, at least 95 wt %, and/or at least 99 wt % of polyurethane resins, epoxy resins, and/or polyurethane/epoxy hybrid resins, based on the total weight of the resins in the resultant coating.

For example, the sulfide capturing agent, such as zinc oxide, may be embedded into a polyurethane based matrix and/or epoxy based matrix, which acts as a permeable or semi-permeable polymer resin. In exemplary embodiments, the zinc oxide is embedded within a matrix that includes polyurethane polymers, epoxy polymers, or hybrid polyurethane/epoxy polymers. The sulfur ions may be rendered immobile on an outer surface of the sulfide recovery coating by the sulfide capturing agent and/or the polyurethane based matrix and/or epoxy based matrix; and/or the sulfur ions may be rendered immobile embedded within the polyurethane based matrix and/or epoxy based matrix. The polyurethane based matrix may additionally provide benefits associated with coatings having a polyurethane based coating thereon, such as enhanced strength. The epoxy based matrix may additionally provide benefits associated with an epoxy coating.

### Polyurethane Based Coating

Polyurethane based coatings (e.g., based on polyurethane chemistry), have been proposed for use in forming the polymer resin matrix of the sulfide recovery coating. As used herein, the term polyurethane encompasses the reaction product of a polyol (e.g., simple polyol, polyether polyol, natural oil polyol, natural oil derived polyol, and/or polyester polyol) with an isocyanate index range over all possible isocyanate indices (e.g., from 50 to 1000). Polyurethanes offer various advantages in resin-coating applications, e.g., such as ease of processing, base stability, and/or rapid cure rates that enable short cycle times for forming the coating.

For example, polyurethane based matrix may be the reaction product of an isocyanate component and/or an isocyanate-reactive component. For a polyurethane based matrix, the isocyanate component may include a polyisocyanate and/or an isocyanate-terminated prepolymer and the isocyanate-reactive component may include a polyether polyol. For a polyurethane/epoxy hybrid based matrix, the isocyanate component may include a polyisocyanate and/or an isocyanate-terminated prepolymer and the isocyanate-reactive component may include an epoxy resin containing hydroxyl groups and optionally a polyether polyol. Similarly, the optional one or more polyurethane based undercoats, under the sulfide recovery coating, may be the reaction product of a same or a different isocyanate component and a same or a different isocyanate-reactive component. In exemplary embodiments, a single isocyanate component may be used to form both a polyurethane based undercoat and a separately formed polyurethane based matrix. For example, a first isocyanate-reactive component may be added to the base substrate to start the formation of the polyurethane based undercoat, then a first isocyanate component may be added to the resultant mixture to form the polyurethane based undercoat, and then a second isocyanate-reactive component (e.g., that includes the sulfide capturing crystals in the carrier polyol) may be added to the resultant mixture to form the sulfide recovery coating. In other exemplary embodiments, one isocyanate-reactive component (e.g., that includes the sulfide capturing crystals in one or more polyols that includes at least a carrier polyol) and one isocyanate component may be used to form the polyurethane based matrix and formation of an additional coating thereunder may be excluded.

For forming the polyurethane based matrix and/or the optional polyurethane based undercoat, the amount of the isocyanate component used relative to the isocyanate-reactive component in the reaction system expressed as the isocyanate index. For example, the isocyanate index may be from 60 to 2000 (e.g., 65 to 1000, 65 to 300, 65 to 250 and/or 70 to 200 etc.). The isocyanate index is the equivalents of isocyanate groups (i.e., NCO moieties) present, divided by the total equivalents of isocyanate-reactive hydrogen containing groups (i.e., OH moieties) present, multiplied by 100. Considered in another way, the isocyanate index is the ratio of the isocyanate groups over the isocyanate reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

The isocyanate component for forming the polyurethane based matrix (including a polyurethane/epoxy hybrid based matrix) and/or the polyurethane based undercoat may include one or more polyisocyanates, one or more isocyanate-terminated prepolymer derived from the polyisocyanates, and/or one or more quasi-prepolymers derived from the polyisocyanates. Isocyanate-terminated prepolymers and quasi-prepolymers (mixtures of prepolymers with unreacted polyisocyanate compounds), may be prepared by reacting a stoichiometric excess of a polyisocyanate with at least one polyol. Exemplary polyisocyanates include aromatic, aliphatic, and cycloaliphatic polyisocyanates. According to exemplary embodiments, the isocyanate component may only include aromatic polyisocyanates, prepolymers (e.g., isocyanate-terminated prepolymers) derived therefrom, and/or quasi-prepolymers derived therefrom, and the isocyanate component may exclude any aliphatic isocyanates and any cycloaliphatic polyisocyanates. The polyisocyanates may have an average isocyanate functionality from 1.9 to 4 (e.g., 2.0 to 3.5, 2.8 to 3.2, etc.). The polyisocyanates may have an average isocyanate equivalent weight from 80 to 160 (e.g., 120 to 150, 125 to 145, etc.).

In exemplary embodiments, a one-component system includes an isocyanate-terminated prepolymer such that the composition for forming the polyurethane matrix. The isocyanate-terminated prepolymer may have a free NCO content from 5 wt % to 30 wt % (e.g., 5 wt % to 25 wt %, 5 wt % to 20 wt %, 8 wt % to 18 wt %, etc.). The isocyanate-terminated prepolymer may account for from 20 wt % to 90 wt % (e.g., 20 wt % to 80 wt %, 20 wt % to 60 wt %, 30 wt % to 60 wt %, 30 wt % to 50 wt %, 40 wt % to 50 wt %, etc.) of a total weight of the composition for forming the sulfide recovery coating. The one-component system for the polyurethane matrix may further include a solvent, such as xylene, that may be evaporated from the final dry film of the sulfide recovery coating. The solvent may account for 1 wt % to 70 wt % (e.g., 5 wt % to 50 wt %, 5 wt % to 25 wt %, 10 wt % to 20 wt %, etc.) of a total weight of the one-component system.

In exemplary embodiments, a two-component system includes an isocyanate component having an aromatic polyisocyanate and/or the isocyanate-terminated prepolymer described above. For example, a two-component system may include from 10 wt % to 95 wt % (e.g., 20 wt % to 90 wt %, 40 wt % to 85 wt %, 50 wt % to 80 wt %, 60 wt % to 70 wt %, etc.) of the polyisocyanate and from 5 wt % to 90 wt % (e.g., 10 wt % to 70 wt %, 15 wt % to 50 wt %, 20 wt % to 40 wt %, 25 wt % to 35 wt %, etc.) of the isocyanate-terminated prepolymer, based on the total weight of the isocyanate component of the two-component system.

Exemplary isocyanates include toluene diisocyanate (TDI) and variations thereof known to one of ordinary skill in the art, and diphenylmethane diisocyanate (MDI) and variations thereof known to one of ordinary skill in the art. Other isocyanates known in the polyurethane art may be used, e.g., known in the art for polyurethane based coatings. Examples, include modified isocyanates, such as derivatives that contain biuret, urea, carbodiimide, allophonate and/or isocyanurate groups may also be used. Exemplary available isocyanate based products include PAPI™ products, ISONATE™ products and VORANATE™ products, VORASTAR™ products, HYPOL™ products, HYPERLAST™ products, TERAFORCE™ Isocyanates products, available from The Dow Chemical Company.

The isocyanate-reactive component for forming the polyurethane based matrix (including a polyurethane/epoxy hybrid based matrix) and/or the polyurethane based undercoat includes one or more polyols that are separate from the optional carrier polyol or that include the optional carrier polyol. For example, if the isocyanate-reactive component is added at the same time as the sulfide capturing crystals, the isocyanate-reactive component may include the optional carrier polyol. If the optional polyurethane undercoat layer is formed before forming the sulfide recovery coating, the one or more polyols excludes the carrier polyol. The isocyanate-reactive may include a catalyst component having at least a catalyst (and optionally additional catalysts).

Exemplary polyols include a polyether polyol, a polyester polyol, a simple polyol, a natural oil polyol, and/or a natural oil derived polyol, such as discussed above with respect to the carrier polymer. The at least one polyol may be a polyether polyol that has a number average molecular weight from 60 g/mol to 6000 g/mol (and optionally additional polyols). The at least one polyol may have on average from 1 to 8 hydroxyl groups per molecule, e.g., from 2 to 4 hydroxyl groups per molecule. For example, the at least one polyol may independently be a diol or triol. For example, one or more included polyether polyols may have a number average molecular weight from 60 g/mol to 6000 g/mol (e.g., 150 g/mol to 3000 g/mol, 150 g/mol to 2000 g/mol, 150 g/mol to 1500 g/mol, 150 g/mol to 1000 g/mol, 150 g/mol to 500 g/mol, 200 g/mol to 500 g/mol, 250 g/mol to 500 g/mol, etc.). In exemplary embodiments, one or more included polyether polyols may be present in an amount from 15 wt % to 80 wt %, 15 wt % to 60 wt %, 20 wt % to 50 wt %, 20 wt % to 40 wt %, and/or 25 wt % to 35 wt % of the total weight of the isocyanate-reactive component.

The isocyanate-reactive component may include a polyol, such as one or more polyether polyols, that are alkoxylates derived from the reaction propylene oxide, ethylene oxide, and/or butylene oxide with an initiator. Initiators known in the art for use in preparing polyols for forming polyurethane polymers may be used. For example, the one or more polyols may be an alkoxylate of alcohols, e.g., ethylene glycol, diethylene glycol, triethylene glycol, 1,2-propanediol, dipropylene glycol, tripropylene glycol, 1,4-butanediol, 1,6-hexanediol, and glycerol. The one or more polyols may be an alkoxylate of ammonia or primary or secondary amine compounds, e.g., as aniline, toluene diamine, ethylene diamine, diethylene triamine, piperazine, methylene diphenyl diamine, and/or aminoethylpiperazine. According to exemplary embodiments, the one or more polyols may be derived from propylene oxide and ethylene oxide, of which less than 20 wt % (e.g., and greater than 5 wt %) of polyol is derived from ethylene oxide, based on a total weight of the alkoxylate. According to another exemplary embodiment, the polyol contains terminal ethylene oxide blocks. According to other exemplary embodiments, the polyol may be the initiator themselves as listed above, without any alkylene oxide reacted to it.

The isocyanate-reactive component may include a natural oil polyol, e.g., in addition to the one or more polyether polyols. For example, the natural oil hydrophobic polyol may account for 15 wt % to 80 wt %, 15 wt % to 60 wt %, 20 wt % to 50 wt %, 20 wt % to 40 wt %, and/or 25 wt % to 35 wt % of the total weight of the isocyanate-reactive component. The natural oil polyol may be di- and/or tri-glycerides of aliphatic carboxylic acids of 10 carbon atoms or more, e.g., triglycerides of hydroxyl substituted aliphatic carboxylic acids. An example is castor oil, which is a vegetable oil obtained from the castor seed/plant. A majority of the fatty acids in castor oil may be ricinoleate/ricinoleic acid (i.e., 12 hydroxy-9-cis-octadecenoic acid), which can be referred to as a monounsaturated, 18 carbon fatty acid having a hydroxyl functional group at the twelfth carbon. This functional group causes ricinoleic acid (and castor oil) to be polar, e.g., having polar dielectric with a relatively high dielectric constant (4.7) for highly refined and dried castor oil. An exemplary castor oil may include at least 85 wt % of ricinoleic acid (12-hydroxyoleic acid) and minor amounts of linoleic acid, oleic acid, stearic acid, palmitic acid, dihydroxystearic acid, linolenic acid, elcosanoic acid, and/or water. Castor oil may have a true hydroxyl functionality of approximately 2.64 and an equivalent weight of approximately 342. The castor oil may be modified or unmodified, e.g., modified castor oil may contain an additive such as a formaldehyde or polyester polyol.

The isocyanate-reactive component may include a natural oil derived polyol or prepolymer derived thereform, e.g., as discussed in U.S. Pat. No. 7,615,658, U.S. Pat. No. 8,124,812, U.S. Pat. No. 8,394,868, and U.S. Pat. No. 8,686,057. Optionally, the isocyanate component may include the natural oil derived prepolymer.

The isocyanate-reactive component may include a polyester polyol, e.g., having a hydroxyl equivalent weight of at least 500, at least 800, and/or at least 1,000. For example, polyester polyols known in the art for forming polyurethane polymers may be used. The isocyanate-reactive component may include a polyol with fillers (filled polyol), e.g., where the hydroxyl equivalent weight is at least 500, at least 800, and/or at least 1,000. The filled polyols may contain one or more copolymer polyols with polymer particles as a filler dispersed within the copolymer polyols. Exemplary filled polyols include styrene/acrylonitrile (SAN) based filled polyols, polyharnstoff dispersion (PHD) filled polyols, and polyisocyanate polyaddition products (PIPA) based filled polyols.

When the isocyanate-reactive component is used to form the sulfide recovery coating, the isocyanate-reactive component may include at least 50 wt %, at least 60 wt %, and/or at least 65 wt % of the one or more polyols (e.g., a low molecular weight polyol having a number average molecular weight of from 150 g/mol to 500 g/mol), and the amount of the one or more polyols may be less than 90 wt %, less than 80 wt %, and/or less than 75 wt % based on a total weight of the isocyanate-reactive component. When the isocyanate-reactive component is used to form an optional polyurethane based undercoat layer, the isocyanate-reactive component may include at least 80 wt % and/or at least 90 wt % of one or more low molecular weight polyols (e.g., a number average molecular weight of from 150 g/mol to 1000 g/mol), based on a total weight of the isocyanate-reactive component.

Exemplary available polyol based products include VORANOL™ products, TERAFORCE™ Polyol products, VORAPEL™ products, SPECFLEX™ products, VORALUX™ products, PARALOID™ products, VORARAD™ products, available from The Dow Chemical Company.

The isocyanate-reactive component for forming the polyurethane based matrix and/or the polyurethane based undercoat may further include a catalyst component. The catalyst component may include one or more catalysts. Catalysts known in the art, such as trimerization catalysts known in art for forming polyisocyanates trimers and/or urethane catalyst known in the art for forming polyurethane polymers and/or coatings may be used. In exemplary embodiments, the catalyst component may be pre-blended with the isocyanate-reactive component, prior to forming the coating (e.g., an undercoat or a sulfide recovery outer coating).

Exemplary trimerization catalysts include, e.g., amines (such as tertiary amines), alkali metal phenolates, alkali metal alkoxides, alkali metal carboxylates, and quaternary ammonium carboxylate salts. The trimerization catalyst may be present, e.g., in an amount less than 5 wt %, based on the total weight of the isocyanate-reactive component. Exemplary urethane catalyst include various amines, tin containing catalysts (such as tin carboxylates and organotin compounds), tertiary phosphines, various metal chelates, and metal salts of strong acids (such as ferric chloride, stannic chloride, stannous chloride, antimony trichloride, bismuth nitrate, and bismuth chloride). Exemplary tin-containing catalysts include, e.g., stannous octoate, dibutyl tin diacetate, dibutyl tin dilaurate, dibutyl tin dimercaptide, dialkyl tin dialkylmercapto acids, and dibutyl tin oxide. The urethane catalyst, when present, may be present in similar amounts as the trimerization catalyst, e.g., in an amount less than 5 wt %, based on the total weight of the isocyanate-reactive component. The amount of the trimerization catalyst may be greater than the amount of the urethane catalyst. For example, the catalyst component may include an amine based trimerization catalyst and a tin-based urethane catalyst.

### Epoxy Resin Based Coating

Epoxy resin based coatings (e.g., based on epoxy and epoxy hardener chemistry) have been proposed for use in forming the polymer resin matrix of the sulfide recovery coating. As used herein, epoxy based coatings encompass the chemistry of an epoxy resin and an amine based epoxy hardener, with an amino hydrogen/epoxy resin stoichiometric ratio range over all possible stoichiometric ratios (e.g., from 0.60 to 3.00, from 0.60 to 2.00, from 0.70 to 2.0, etc.). The epoxy resin used may be a liquid epoxy resin, a solid epoxy resin, or a combination/mixture thereof.

Polyurethane/epoxy hybrid coatings incorporate both epoxy based chemistry and polyurethane based chemistry to form hybrid polymers. For example, polyurethane/epoxy hybrid coatings may be formed by mixing and heating an epoxy resin containing hydroxyl groups, an isocyanate component (such as an isocyanate or an isocyanate-terminated prepolymer, and optionally a polyol component (e.g., may be excluded when an isocyanate-terminated prepolymer is used). Thereafter, an epoxy hardener may be added to the resultant polymer. Liquid epoxy resins known in the art may be used to form such a coating.

Polyurea/epoxy hybrid coatings incorporate both epoxy-amine adducts based chemistry and polyurea based chemistry to form hybrid polymers. For example, polyurea/epoxy hybrid coatings may be formed by mixing and heating an epoxy-amine adduct hardener containing amino-hydrogen groups, an isocyanate component (such as an isocyanate or an isocyanate-terminated prepolymer, and optionally a polyol component (e.g., may be excluded when an isocyanate-terminated prepolymer is used).

For example, for the epoxy based matrix, the liquid epoxy resin may be cured by one or more hardener, which may be any conventional hardener for epoxy resins. Conventional hardeners may include, e.g., any amine or mercaptan with at least two epoxy reactive hydrogen atoms per molecule, anhydrides, phenolics. In exemplary embodiments, the hardener is an amine where the nitrogen atoms are linked by divalent hydrocarbon groups that contain at least 2 carbon atoms per subunit, such as aliphatic, cycloaliphatic, or aromatic groups. For example, the polyamines may contain from 2 to 6 amine nitrogen atoms per molecule, from 2 to 8 amine hydrogen atoms per molecule, and/or 2 to 50 carbon atoms. Exemplary polyamines include ethylene diamine, diethylene triamine, triethylene tetramine, tetraethylene pentamine, pentaethylene hexamine, dipropylene triamine, tributylene tetramine, hexamethylene diamine, dihexamethylene triamine, 1,2-propane diamine, 1,3-propane diamine, 1,2-butane diamine, 1,3-butane diamine, 1,4-butane diamine, 1,5-pentane diamine, 1,6-hexane diamine, 2-methyl-1,5-pentanediamine, and 2,5-dimethyl-2,5-hexanediamine; cycloaliphatic polyamines such as, for example, isophoronediamine, 1,3-(bisaminomethyl)cyclohexane, 4,4′-diaminodicyclohexylmethane, 1,2-diaminocyclohexane, 1,4-diamino cyclohexane, isomeric mixtures of bis(4-aminocyclohexyl)methanes, bis(3-methyl-4-aminocyclohexyl)methane (BMACM), 2,2-bis(3-methyl-4-aminocyclohexyl)propane (BMACP), 2,6-bis(aminomethyl)norbornane (BAMN), and mixtures of 1,3-bis(aminomethyl)cyclohexane and 1,4-bis(aminomethyl)cyclohexane (including cis and trans isomers of the 1,3- and 1,4-bis(aminomethyl)cyclohexanes); other aliphatic polyamines, bicyclic amines (e.g., 3-azabicyclo[3.3.1]nonan); bicyclic imines (e.g., 3-azabicyclo[3.3.1]non-2-ene); bicyclic diamines (e.g. 3-azab'i'cyclo[3.3.1]nonan-2-amine); heterocyclic diamines (e.g., 3,4 diaminofuran and piperazine); polyamines containing amide linkages derived from “dimer acids” (dimerized fatty acids), which are produced by condensing the dimer acids with ammonia and then optionally hydrogenating; adducts of the above amines with epoxy resins, epichlorohydrin, acrylonitrile, acrylic monomers, ethylene oxide, and the like, such as, for example, an adduct of isophoronediamine with a diglycidyl ether of a dihydric phenol, or corresponding adducts with ethylenediamine or m-xylylenediamine; araliphatic polyamines such as, for example, 1,3-bis(aminomethyl)benzene, 4,4′diaminodiphenyl methane and polymethylene polyphenylpolyamine; aromatic polyamines (e.g., 4,4′-methylenedianiline, 1,3-phenylenediamine and 3,5-diethyl-2,4-toluenediamine); amidoamines (e.g., condensates of fatty acids with diethylenetriamine, triethylenetetramine, etc.); polyamides (e.g., condensates of dimer acids with diethylenetriamine, triethylenetetramine; oligo(propylene oxide)diamine; and Mannich bases (e.g., the condensation products of a phenol, formaldehyde, and a polyamine or phenalkamines). Mixtures of more than one diamine and/or polyamine can also be used.

A toughener, such as an epoxy toughener, may be used in the composition. Any tougheners may be used, including, e.g., toughing agents, epoxy tougheners, flexbilizers, rubber epoxy resins, and/or capped polyurethanes (blocked PU). For example, from 5 wt % to 20 wt % (e.g., 10 wt % to 20 wt %, 10 wt % to 15 wt %, etc.), based on a total weight of forming the composition for forming the sulfide recovery coating. For example, the toughener may be used in the epoxy system such as, with a high content of sulfide capturing agent, to reduce coatings brittleness. Examples include acrylic impact modifiers like PARALOID™ TMS-2670 and PARALOID™ EXL series available from The Dow Chemical Company, urethane acrylates like VORASPEC™ 58 available from The Dow Chemical Company, core-shell rubber dispersions like KANE ACE® MX series available from KANEKA CORPORATION, block copolymers like FORTEGRA 100 from Olin Corporation, and carboxyl-terminated butadiene and butadiene-acrylonitrile copolymers (CTBN) available from Emerald Performance Chemicals.

### Other Coatings

Under or embedded with the sulfide recovery coating, may be a heavy metal recovery coating such as discussed in priority document, U.S. Provisional Patent Application No. 62/186,645. In particular, the heavy metal recovery coating may have heavy metal recovery crystals embedded within a polymer resin matrix. The metal sulfate crystals may aid in heavy metal recovery by causing heavy metals, such as particles of radioactive radium, to partition onto the coating and away from the contaminated water. The selective post-precipitation of heavy metals such radium ions onto previously formed crystals (e.g., barite crystals) by lattice replacement (lattice defect occupation), adsorption, or other mechanism, is distinctly different from other capture modes such as ion exchange or molecular sieving. For example, the post precipitation of heavy metals such as radium on pre-formed barite crystals is selective for radium because of similar size and electronic structure of radium and barium. In exemplary embodiments, the heavy metal recovery crystals may form a crystalline structure that is appropriately sized to hold the heavy metals such as radium thereon or therewithin. Therefore, the heavy metal recovery crystals may pull the radium out of fracturing fluid and hold the ions on or within the heavy metal recovery coating, so as to reduce radium content in the fracturing fluid.

In exemplary embodiments, the sulfide recovery coating may include both the sulfide capturing agent and the heavy metal recovery crystals embedded within a same polymer resin matrix, to form both the sulfide recovery coating and the heavy mental recovery coating.

Under or combined with the sulfide recovery coating, may optionally be at least one additional coating/layer derived from one or more preformed isocyanurate tri-isocyanates, such as discussed in U.S. Provisional Patent Application No. 62/140,022. For example, the additional coating/layer may be formed between a polymer resin based undercoat and the sulfide recovery coating. In embodiments, the additional layer is derived from a mixture that includes one or more preformed isocyanurate tri-isocyanates and one or more curatives. The preformed isocyanurate tri-isocyanate may also be referred to herein as an isocyanate trimer and/or isocyanurate trimer. By preformed it is meant that the isocyanurate tri-isocyanate is prepared prior to making a coating that includes the isocyanurate tri-isocyanate there within. Accordingly, the isocyanurate tri-isocyanate is not prepared via in situ trimerization during formation of the coating. In particular, one way of preparing polyisocyanates trimers is by achieving in situ trimerization of isocyanate groups, in the presence of suitable trimerization catalyst, during a process of forming polyurethane polymers. For example, the in situ trimerization may proceed as shown below with respect to Schematic (a), in which a diisocyanate is reacted with a diol (by way of example only) in the presence of both a urethane catalyst and a trimerization (i.e. promotes formation of isocyanurate moieties from isocyanate functional groups) catalyst. The resultant polymer includes both polyurethane polymers and polyisocyanurate polymers, as shown in Schematic (a), below.

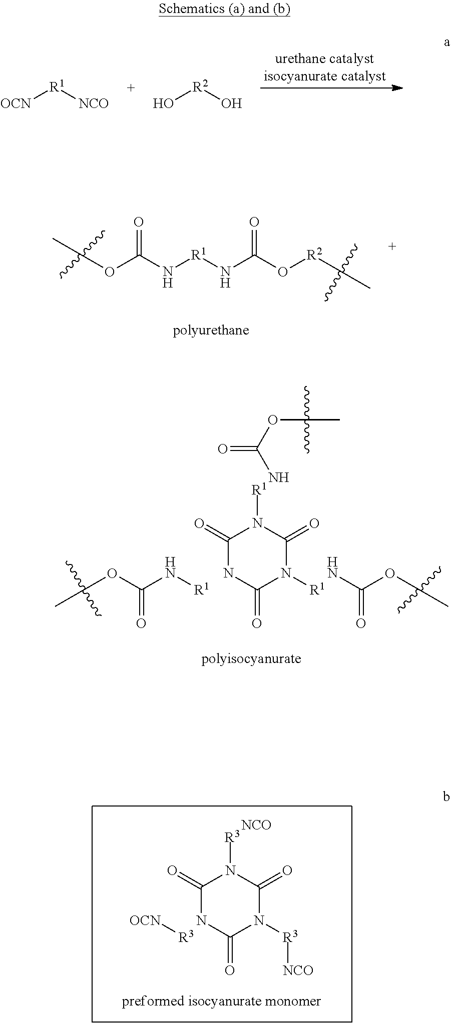

In contrast, referring to Schematic (b) above, in embodiments the preformed isocyanurate tri-isocyanate is provided as a separate preformed isocyanurate-isocyanate component, i.e., is not mainly formed in situ during the process of forming polyurethane polymers. The preformed isocyanurate tri-isocyanate may be provided in a mixture for forming the coating in the form of a monomer, and not in the form of being derivable from a polyisocyanate monomer while forming the coating. For example, the isocyanate trimer may not be formed in the presence of any polyols and/or may be formed in the presence of a sufficiently low amount of polyols such that a polyurethane forming reaction is mainly avoided (as would be understand by a person of ordinary skill in the art). With respect to the preformed isocyanurate tri-isocyanate, it is believed that the existence of isocyanurate rings leads to a higher crosslink density. Further, the higher crosslink density may be coupled with a high decomposition temperature of the isocyanurate rings, which may lead to enhanced temperature resistance.

For example, the additional layer may include one or more preformed aliphatic isocyanate based isocyanurate tri-isocyanates, one or more preformed cycloaliphatic isocyanate based isocyanurate tri-isocyanates, or combinations thereof. In exemplary embodiments, the additional layer is derived from at least a preformed cycloaliphatic isocyanate based isocyanurate tri-isocyanate, e.g., the preformed cycloaliphatic isocyanate based isocyanurate tri-isocyanate may be present in an amount from 80 wt % to 100 wt %, based on the total amount of the isocyanurate tri-isocyanates used in forming the additional layer.

Exemplary preformed isocyanurate tri-isocyanates include the isocyanurate tri-isocyanate derivative of 1,6-hexamethylene diisocyanate (HDI) and the isocyanurate tri-isocyanate derivative of isophorone diisocyanate (IPDI). For example, the isocyanurate tri-isocyanates may include an aliphatic isocyanate based isocyanurate tri-isocyanates based on HDI trimer and/or cycloaliphatic isocyanate based isocyanurate tri-isocyanates based on IPDI trimer. Many other aliphatic and cycloaliphatic di-isocyanates that may be used (but not limiting with respect to the scope of the embodiments) are described in, e.g., U.S. Pat. No. 4,937,366. It is understood that in any of these isocyanurate tri-isocyanates, one can also use both aliphatic and cycloaliphatic isocyanates to form an preformed hybrid isocyanurate tri-isocyanate, and that when the term “aliphatic isocyanate based isocyanurate tri-isocyanate” is used, that such a hybrid is also included.

The one or more curatives (i.e., curative agents) may include an amine based curative such as a polyamine and/or an hydroxyl based curative such as a polyol. For example the one or more curatives may include one or more polyols, one or more polyamines, or a combination thereof. Curative known in the art for use in forming coatings may be used. The curative may be added, after first coating the base substrate with the preformed aliphatic or cycloaliphatic isocyanurate tri-isocyanate. The curative may act as a curing agent for both the top coat and the undercoat. The curative may also be added, after first coating following the addition of the preformed aliphatic or cycloaliphatic isocyanurate tri-isocyanate in the top coat.

Various optional ingredients may be included in the reaction mixture for forming the controlled release polymer resin based coating, the additive based coating, and/or the above discussed additional coating/layer. For example, reinforcing agents such as fibers and flakes that have an aspect ratio (ratio of largest to smallest orthogonal dimension) of at least 5 may be used. These fibers and flakes may be, e.g., an inorganic material such as glass, mica, other ceramic fibers and flakes, carbon fibers, organic polymer fibers that are non-melting and thermally stable at the temperatures encountered in the end use application. Another optional ingredient is a low aspect ratio particulate filler. Such a filler may be, e.g., clay, other minerals, or an organic polymer that is non-melting and thermally stable at the temperatures encountered in stages (a) and (b) of the process. Such a particulate filler may have a particle size (as measured by sieving methods) of less than 100 μm. With respect to solvents, the undercoat may be formed using less than 20 wt % of solvents, based on the total weight of the isocyanate-reactive component.

Another optional ingredient includes a liquid epoxy resin. The liquid epoxy resin may be added in amounts up to 20 wt %, based on the total weight of the reaction mixture. Exemplary liquid epoxy resins include the glycidyl polyethers of polyhydric phenols and polyhydric alcohols. Other optional ingredients include colorants, biocides, UV stabilizing agents, preservatives, antioxidants, and surfactants. Although it is possible to include a blowing agent into the reaction mixture to improve permeability, in some embodiments the blowing agent is excluded from the reaction mixture.

Other optional ingredients include a flow aid, leveling aid, and dispersing aid (e.g., at a concentration of from 0.2 wt % to 2.0 wt %. For example, such aids can include Polyether-modified polydimethylsiloxane to reduce surface tension like BYK-333 available from BYK-Chemie GmbH; polyether-modified polymethylalkylsiloxane as leveling and defoaming agents like BYK-320 from BYK-Chemie GmbH.

Polysiloxanes as antifoaming agents like BYK-066 N. thickening, thixotrophic (shear-thinning), and anti-settling agents like CAB-O-SIL® EH-5 from Cabot Corporation useful for improving pigment and filler dispersion and processing) to homogenously disperse the above components, particularly the above particulate material

Epoxy functional silanes which may be suitable for use as adhesion promoters like Silquest A-187 from Momentive Performance Materials Inc. The coating composition may also optionally include an accelerator including, but are not limited to, imidazoles, anhydrides, polyamides, aliphatic amines, epoxy resin-amine adducts, and tertiary amines. An accelerator may be present at a concentration of from 0.1 wt % to 3.0 wt %. An example of a suitable commercially available accelerator includes, but is not limited to, Tris-(dimethylaminomethyl) phenol, Nonyl phenol Benzyldimethylamine, Triethanolamine, amino-n-propyldiethanolamine, N,N-dimethyldipropylenetriamine.

Prior to forming any coating on the base substrate (e.g., under the polymer resin matrix and/or the optional polymer resin based undercoat), a coupling agent may be added, e.g., prior to adding an isocyanate-reactive component. For example, the coupling agent may be a silane based compound such as an aminosilane compound.

### Coating Process

The coating process may involve a batch process, an intermittent process, or a continuous process using equipment well known to those skilled in the art. For example, to coat the base substrate, techniques known in the art may be used such as spraying, brushing (includes rolling), pouring in place, powder coatings, etc. In some instances, the coating composition may be applied form inside a downhole tube or pipeline using equipment known to those skilled in the art. In another example, the coating composition may be applied to large tanks and containers using spray equipment know to those skilled in the art. In exemplary embodiments any optional undercoat layer (e.g., an epoxy or polyurethane based layer or primer) may be formed first. Thereafter, the sulfide recovery coating prepared using sulfide recovery crystals and the polymer resin matrix may be formed on (e.g., directly on) the base substrate and/or the optional underlying undercoat.

For forming the sulfide recovery coating, the sulfide capturing agent and the polymer resin matrix of the sulfide recovery coating may be sprayed or brushed on to the base substrate at a same time. By at a same time it is meant the both the sulfide capturing agent and the polymer resin matrix are applied to the base substrate together (i.e., in a concurrent stage or step).

An exemplary a process of may include the following stages: (1) preparing a coating composition comprising at least the following components: (a) at least one composition for forming the polymer resin matrix and (b) at least one sulfide recovery agent; and (2) attaching, adhering or bonding the coating composition of stage (1) onto base substrate. Stage (2) may include processing the above coating composition to form a permeable liner on the base substrate by reacting/curing the composition of stage (1). The coating composition may be applied at ambient conditions in the field. Thus, the application of the coating can be done e.g., by brush, by roller, by dipping, by spraying (air-less or air-assisted) using equipment known to those skilled in the art. The coating may be applied in a dry film thickness of from 25 microns to 3000 microns. The coating cures at ambient conditions and may be in service in a period from 1 to 7 days. The coating may be applied to the base substrate (e.g., tube, pipe) in a factory at ambient conditions and optionally baked at a higher temperature (e.g., greater than or equal to 40° C., greater than or equal to 180° C., greater than or equal to 100° C., greater than or equal to 140° C., and/or from 140° C. to 240° C.).

In an exemplary embodiment, the sulfide recovery coating is a one component of two components liquid coating material made from the above composition, whereas the liquid coating is useful for making a coating and/or liner for capturing contaminants. In another exemplary embodiment, the coating functions as a permeable layer for capturing contaminants, which coating is formed on the base substrate and may be made from the liquid coating material. In another exemplary embodiment, the coating is a permeable liner that functions as a permeable layer for capturing contaminants, which permeable liner may be adhered to the base substrate and may be made from the liquid coating material. A coating composition in powder form may be dissolved in a solvent (such as xylene) and then be applied in liquid form.

Depending on the type of components used, the curable composition may be applied in liquid form direct to a metal substrate (for instance tubes or pipelines used for extraction and transportation of crude oil) or a metal substrate coated with a primer (undercoat). The curable composition can be also applied to composite and proppants applications.

All parts and percentages are by weight unless otherwise indicated. All molecular weight information is based on number average molecular weight, unless indicated otherwise.

### EXAMPLES

Approximate properties, characters, parameters, etc., are provided below with respect to various working examples, comparative examples, and the materials used in the working and comparative examples.

### Polyurethane Based Examples

For polyurethane based examples, the materials principally used, and the corresponding approximate properties thereof, are as follows:

| | |
|---|---|
| Polyol 1 | A polyether polyol derived from propylene oxide, |
| | ethylene oxide, and ethylenediamine, and having |
| | a number average molecular weight of 278 and a |
| | nominal hydroxyl functionality of 4 (available |
| | from The Dow Chemical Company as |
| | VORANOL ™ 800). |
| Polyol 2 | A polypropylene glycol (polyol) having a number |
| | average molecular weight of 425 (available from |
| | The Dow Chemical Company as DOW ™ P425 |
| | polyglycols). |
| Castor Oil | A plant derived hydrophobic polyol that includes |
| | a majority of ricinoleic acid (available from |
| | Alberdingk Boley). |
| Chain Extender | 1,4-Butanediol (available from Sigma-Aldrich). |
| Zinc Oxide | A powder that is described as including 100 wt % |
| | of zinc oxide (available from UNICAT Catalyst |
| | Technologies as product code SLZ1009). |
| Prepolymer 1 | An isocyanate-terminated prepolymer having a |
| | free NCO content around 16 wt % (available from |
| | The Dow Chemical Company as VORASTAR ™ |
| | AP 1600 Prepolymer). |
| Prepolymer 2 | An isocyanate-terminated prepolymer having a |
| | free NCO content around 9.5 wt % (available from |
| | The Dow Chemical Company as HYPERLAST ™ |
| | LE 5008 Prepolymer). |
| Isocyanate | A modified - methylene diphenyl diisocyanate |
| | (MDI) (available from The Dow Chemical |
| | Company as ISONATE ™ 143L). |
| Solvent | Xylene (available from Sigma-Aldrich). |
| Catalyst 1 | A bismuth based catalyst (available from |
| | REAXIS as Reaxis ® C 716). |
| Catalyst 2 | A dimethyltin dineodecanoate catalyst (available |
| | from Momentive as Fomrez ™ catalyst UL-28). |

The approximate conditions (e.g., with respect to time and amounts) and properties for forming Working Examples 1 and 2 and Comparative Examples A and B, are discussed below.

### Working Example 1 and Comparative Example A

Working Example 1 illustrates an exemplary sulfide recovery coating in which the polymer resin matrix is a polyurethane based matrix that a cured product of an isocyanate-terminated prepolymer. The exemplary sulfide capturing agent zinc oxide is introduced/mixed with the liquid isocyanate-terminated prepolymer and an optional solvent prior to the curing process.

The resultant coating sample of Working Example 1 includes 20 vol % of Zinc Oxide embedded in a polyurethane polymer matrix. For Working Example 1, a modified Prepolymer 1 is prepared by mixing the Prepolymer 1 with Solvent, to form a resultant solution include 15 wt % of the Solvent based on the total weight of the modified Prepolymer 1 solution. Next, 25 grams of the modified Prepolymer 1 is mixed with 25 grams of Zinc Oxide. The resultant blend is spread on a glass surface and allowed to cure for a period of 48 hours at ambient conditions to form a coating film sample. Referring to Table 1, below, for Working Example 1 the film composition and the resultant film sample are characterized as follows:

TABLE 1
Working Example 1

| | Composition | Composition | Composition |
|---|---|---|---|
| | for forming | for forming | of Dry |
| | Film | Film | Film |
| | (wt %) | (vol %) | (vol %) |
| Prepolymer 1 | 43 | 66.8 | 80 |
| Solvent | 8 | 16.4 | 0 |
| Zinc Oxide | 50 | 16.8 | 20 |

The resultant coating sample of Comparative Example A includes the polyurethane polymer matrix, without the Zinc Oxide. Similar to Working Example 1, Comparative Example A is prepared by first mixing the Prepolymer 1 with Solvent, to form a resultant solution include 15 wt % of the Solvent based on the total weight of the modified Prepolymer 1 solution. The resultant blend is spread on a glass surface and allowed to cure for a period of 48 hours at ambient conditions to form a coating film sample. Referring to Table 2, below, for Comparative Example A the film composition and the resultant film sample are characterized as follows:

TABLE 2
Comparative Example A

| | Composition | Composition | Composition |
|---|---|---|---|
| | for forming | for forming | of Dry |
| | Film | Film | Film |
| | (wt %) | (vol %) | (vol %) |
| Prepolymer 1 | 85 | 80 | 100 |
| Solvent | 15 | 20 | 0 |
| Zinc Oxide | 0 | 0 | 0 |

Working Example 1 is prepared to measure the ability of the coating film sample to remove hydrogen sulfite from an aqueous media, as compared to Comparative Example A.

### Working Example 2 and Comparative Example B

Working Example 2 illustrates an exemplary sulfide recovery coating in which the polymer resin matrix is a polyurethane based matrix that a reaction product of an isocyanate component and an isocyanate-reactive component. The exemplary sulfide capturing agent zinc oxide is introduced/mixed with the isocyanate-reactive component prior to the isocyanate component being reacted with the isocyanate-reactive component.

The resultant coating sample of Working Example 2 includes 7 vol % of Zinc Oxide embedded in a polyurethane polymer matrix. For Working Example 2, the Isocyanate-Reactive Component and the Isocyanate Component are prepared according to the formulations in Table 3. In particular, the Isocyanate-Reactive Component is prepared by mixing the Polyol 1, Polyol 2, Castor Oil, Chain Extender, Catalyst 1, and Catalyst 2 with the Zinc Oxide. Next, 50 mL of the Isocyanate-Reactive Component is mixed with 50 mL of the Isocyanate Component, for 10 seconds. The resultant blend is spread on a glass surface and allowed to cure for a period of 3 minutes at ambient conditions to form a coating film sample. Referring to Table 3, below, for Working Example 2 the film composition and the resultant film sample are characterized as follows:

TABLE 3
Working Example 2

| | |
|---|---|
| Composition | Composition |
| for forming | for forming |
| Film | Film |
| (wt %) | (vol %) |

Isocyanate-Reactive Component

| | | |
|---|---|---|
| Polyol 1 | 8.9 | 11.6 |
| Polyol 2 | 24.6 | 32.1 |
| Castor Oil | 29.5 | 40.4 |
| Chain Extender | 6.9 | 8.9 |
| Zinc Oxide | 30.1 | 7.0 |
| Catalyst 1 | <0.1 | <0.1 |
| Catalyst 2 | <0.1 | <0.1 |

Isocyanate Component

| | | |
|---|---|---|
| Prepolymer 2 | 30.5 | 32.6 |
| Isocyanate | 69.5 | 67.4 |

The resultant coating sample of Comparative Example B includes the polyurethane polymer matrix, without the Zinc Oxide. Similar to Working Example 2, Comparative Example B is prepared using the Isocyanate-Reactive Component and the Isocyanate Component according to the formulations in Table 4. Next, 50 mL of the Isocyanate-Reactive Component is mixed with 50 mL of the Isocyanate Component, for 10 seconds. The resultant blend is spread on a glass surface and allowed to cure for a period of 3 minutes at ambient conditions to form a coating film sample. Referring to Table 4, below, for Comparative Example B the film composition and the resultant film sample are characterized as follows:

TABLE 4
Comparative Example B

| | |
|---|---|
| Composition | Composition |
| for forming | for forming |
| Film | Film |
| (wt %) | (vol %) |

Isocyanate-Reactive Component

| | | |
|---|---|---|
| Polyol 1 | 12.7 | 12.4 |
| Polyol 2 | 35.2 | 34.5 |
| Castor Oil | 42.2 | 43.4 |
| Chain Extender | 9.9 | 9.6 |
| Zinc Oxide | — | — |
| Catalyst 1 | <0.1 | <0.1 |
| Catalyst 2 | <0.1 | <0.1 |

Isocyanate Component

| | | |
|---|---|---|
| Prepolymer 2 | 30.5 | 32.6 |
| Isocyanate | 69.5 | 67.4 |

Working Example 2 is prepared to measure the ability of the coating to remove hydrogen sulfite from an aqueous media, as compared to Comparative Example B.

### Epoxy Based Examples

For epoxy based examples, the materials principally used, and the corresponding approximate properties thereof, are as follows:

| | |
|---|---|
| Epoxy Resin | A liquid epoxy resin that is a reaction product of |
| | epichlorohydrin and bisphenol A (available from |
| | Olin Corporation as D.E.R. ™ 331). |
| Epoxy Toughener | A toughened epoxy binder (available from The |
| | Dow Chemical Company as VORASPEC ™ 58). |
| Epoxy Hardener | low viscosity modified cycloaliphatic amine |
| | (available from Olin Corporation as |
| | D.E.H ™ 530). |
| Zinc Oxide | A powder that is described as including 100 wt % |
| | of zinc oxide (available from UNICAT Catalyst |
| | Technologies as product code SLZ1009). |

The approximate conditions (e.g., with respect to time and amounts) and properties for forming Working Example 3 and Comparative Example C, are discussed below.

### Working Example 3 and Comparative Examples C and D

Working Example 3 illustrates an exemplary sulfide recovery coating in which the polymer resin matrix is an epoxy based matrix that a cured product of an epoxy resin, an epoxy hardener, and optionally an epoxy toughener. The exemplary sulfide capturing agent zinc oxide is introduced/mixed with the epoxy resin, an epoxy hardener, and optionally an epoxy toughener prior to the curing process.

The resultant coating sample of Working Example 3 includes 10 vol % of Zinc Oxide embedded in an epoxy polymer matrix. For Working Example 3, for two minutes in a FlackTek SpeedMixer™ 33.3 grams of the Epoxy Resin, 9.5 grams of the Epoxy Toughener, and 35.6 grams of Zinc Oxide are mixed. Then, 21.6 grams of the Epoxy Hardener is added and mixing is continued for 3 minutes. The resultant blend is spread on a glass surface and allowed to cure for a period of 7 days at ambient conditions to form a coating film sample. Referring to Table 5, below, for Working Example 3 the film composition and the resultant film sample are characterized as follows:

TABLE 5
Working Example 3

| | Composition | Composition |
|---|---|---|
| | for forming | for forming |
| | Film | Film |
| | (wt %) | (vol %) |
| Epoxy Resin | 33.3 | 44.9 |
| Epoxy Toughener | 9.5 | 12.3 |
| Epoxy Hardener | 21.6 | 32.8 |
| Zinc Oxide | 35.6 | 9.9 |

The resultant coating sample of Comparative Example C includes the epoxy matrix, without the Zinc Oxide. Similar to Working Example 3, Comparative Example C is prepared by mixing for two minutes in a FlackTek SpeedMixer™ 51.8 grams of the Epoxy Resin and 14.7 grams of the Epoxy Toughener. Then, 33.5 grams of the Epoxy Hardener is added and mixing is continued for 3 minutes. The resultant blend is spread on a glass surface and allowed to cure for a period of 7 days at ambient conditions to form a coating film sample. Referring to Table 6, below, for Comparative Example C the film composition and the resultant film sample are characterized as follows:

TABLE 6
Comparative Example C

| | Composition | Composition |
|---|---|---|
| | for forming | for forming |
| | Film | Film |
| | (wt %) | (vol %) |
| Epoxy Resin | 51.8 | 49.9 |
| Epoxy Toughener | 14.7 | 13.7 |
| Epoxy Hardener | 33.5 | 36.4 |

The resultant coating sample of Comparative Example D includes the epoxy matrix, without the Zinc Oxide and without the Epoxy Toughener. Similar to Working Example 3, Comparative Example D is prepared by mixing for two minutes in a FlackTek SpeedMixer™ 64.6 grams of the Epoxy Resin and 35.4 grams of the Epoxy Hardener. The resultant blend is spread on a glass surface and allowed to cure for a period of 7 days at ambient conditions. Referring to Table 7, below, the film composition and the resultant film sample have the following formulation:

TABLE 7
Comparative Example D

| | Composition | Composition |
|---|---|---|
| | for forming | for forming |
| | Film | Film |
| | (wt %) | (vol %) |
| Epoxy Resin | 64.6 | 61.8 |
| Epoxy Hardener | 35.4 | 38.2 |

### Evaluation of Properties

Working Examples 1 to 3 and Comparative Examples A to D, are evaluated for hydrogen sulfide capture. The evaluation for hydrogen sulfide captures includes: (i) hydrogen sulfide content in vapor phase after 1 hour of exposure, in parts per million by volume (ppmv), and (ii) hydrogen sulfide capture, in percent. The evaluation is carried out using the ones of the Working Examples that contain 0.2 grams of the Zinc Oxide and the ones of the Comparative Examples without Zinc Oxide, but similar amount of the polymer used in the Working Examples. Samples were placed in 10 mL of deionized water in a GC vial, at a temperature of 40° C. As would be understood by a person of ordinary skill in the art, hydrogen sulfide content in vapor phase is measured by an Agilent gas chromatography equipped with a Restek Rt-Q-Bond column, a thermal conductivity detector, and pulsed discharge ionization detector. Hydrogen sulfide capture efficiency is calculated by comparing with a blank sample in the absence of sand, as would be understood by a person of ordinary skill in the art.

In particular, for the hydrogen sulfide capture studies of the corresponding coating samples are weighted into a 22-mL headspace GC vial with a stir bar. Then, deionized water (10 mL) is added into each vial and sealed with a PTEF lined silicon crimp cap. Next, hydrogen sulfide gas (1.5 mL, STP equivalent to 2.28 mg) is injected into the headspace of each vial. The vials are then heated at 40° C. on top of a stirring hot plate for 1 hour. Thereafter, the vials are cooled and the hydrogen sulfide concentrations in the headspace of the vials are analyzed by headspace gas chromatography.

The results for coatings samples suspending in water are shown in Table 8, below:

TABLE 8

| | Ex. 1 | Ex. 2 | Ex. 3 | Ex. A | Ex. B | Ex. C | Ex. D |
|---|---|---|---|---|---|---|---|
| Amount of Coating | 0.4 | 1.3 | 0.6 | 0.2 | 1.1 | 0.4 | 0.4 |
| (grams) | | | | | | | |
| Amount of Polymer | 50 | 84 | 64 | 100 | 100 | 100 | 100 |
| Matrix in Coating (wt %) | | | | | | | |
| Amount of Zinc Oxide | 50 | 16 | 36 | — | — | — | — |
| in Coating (wt %) | | | | | | | |
| Zinc Oxide in Coating | 50 | 16 | 0.5 | — | — | — | — |
| (wt %) | | | | | | | |
| Amount Zinc Oxide | 0.2 | 0.2 | 0.2 | — | — | — | — |
| Powder (g) | | | | | | | |
| Hydrogen Sulfide | 1550 | 710 | 2008 | 2741 | 2767 | 2829 | 2502 |
| Content in Vapor Phase | | | | | | | |
| (ppmv) | | | | | | | |
| Hydrogen Sulfide | 46.9 | 75.7 | 31.3 | 6.1 | 5.2 | 3.1 | 14.3 |
| Capture (%) | | | | | | | |

Referring to Table 8, it is seen that low hydrogen sulfide content in vapor phase and higher percentage of capture of hydrogen sulfide, is realized for each of Working Examples 1 to 3. In contrast, Comparative Examples A to D, which do not include Zinc Oxide in the coating, each show significantly higher amount of hydrogen sulfide content in vapor phase and significantly lower percentage of capture of hydrogen sulfide.

1. A sulfide recovery coating for containers, tanks, pipes, and pipelines, the sulfide recovery coating comprising:
a sulfide capturing agent embedded within a polymer resin matrix, the sulfide capturing agent being a metal oxide and accounting for less than 70 wt % of a total weight a composition for forming the sulfide recovery coating.

2. The sulfide recovery coating as claimed in claim 1, wherein sulfide capturing agent includes sulfide capturing crystals that have a melting point greater than 500° C.

3. The sulfide recovery coating as claimed in claim 1, wherein sulfide capturing agent includes zinc oxide.

4. The sulfide recovery coating as claimed in claim 1, wherein the polymer resin matrix is a polyurethane based matrix that is a cured product including at least one isocyanate-terminated prepolymer, the sulfide capturing agent being mixed with the at least one isocyanate-terminated prepolymer and optionally a solvent prior to forming the cured product.

5. The sulfide recovery coating as claimed in claim 1, wherein the polymer resin matrix is a polyurethane based matrix that is a reaction product of an isocyanate component and an isocyanate-reactive component, the sulfide capturing agent being mixed with the isocyanate-reactive component prior to the isocyanate-component being reacted with the isocyanate-reactive component.

6. The sulfide recovery coating as claimed in claim 1, wherein the polymer resin matrix is an epoxy based matrix that is a cured product including at least an epoxy resin and an epoxy hardener, the sulfide capturing agent being mixed with the epoxy resin and the epoxy hardener prior to forming the cured product.

7. A coated article, comprising a base substrate and the sulfide recovery coating as claimed in claim 1, wherein:
the base substrate is one of a metal, a metal alloy, a reinforced thermoplastic material, or concrete,
the polymer resin matrix is directly to the base substrate without having an undercoat between the sulfide recovery coating and the base substrate, and
the coated article is one of a container, tank, pipe, or pipeline.

8. The sulfide recovery coating as claimed in claim 7, wherein the sulfide capturing agent and the polymer resin matrix of the sulfide recovery coating are sprayed or brushed on to the base substrate at a same time.

9. A coated article, comprising a base substrate and the sulfide recovery coating as claimed in claim 1, wherein:
the base substrate is one of a metal, a metal alloy, a reinforced thermoplastic material, or concrete,
an undercoat layer selected from a polyurethane based layer, an epoxy based layer, or a phenolic based layer,
the polymer resin matrix is directly on the undercoat layer, such that the undercoat layer is between the base substrate and the polymer resin material, and
the coated article is one of a container, tank, pipe, or pipeline.

10. The sulfide recovery coating as claimed in claim 9, wherein the sulfide capturing agent and the polymer resin matrix of the sulfide recovery coating are sprayed or brushed on to the base substrate at a same time, which same time is after the undercoat layer has been formed on the base substrate.
